(19) United States
(12) Patent Application Publication
(10) Pub. No.: US 2008/0217573 A1
(43) Pub. Date: Sep. 11, 2008

(54) POPPET CARTRIDGE WITH TWO-PIECE POPPET AND PISTON COUPLED BY A FLOATING COUPLER

(76) Inventors: Timothy George Pulcini, Leetonia, OH (US); Mickey Clay Heestand, Salem, OH (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/682,660

(22) Filed: Mar. 6, 2007

(51) Int. Cl. F16K 1/42

(52) U.S. Cl. 251/359; 137/614.04

(57) ABSTRACT

In an example embodiment, there is described herein a two-piece poppet and piston assembly coupled by a floating coupler for use with a poppet cartridge assembly. The two-piece poppet assembly and floating coupler provide axial and radial tolerance that helps to ensure an effective seal (face contact between poppet and liner/seat) and has self aligning properties that help to ensure even wear on dynamic seals.

### BACKGROUND

The present invention relates generally to valves and more specifically to a poppet cartridge with a two-piece poppet and piston coupled by a floating coupler such as are used in poppet style directional control valves used in hydraulic systems that are used to control movement of hydraulic cylinders.

A poppet cartridge functions as a two (2) way, two (2) position (open/close) valve. Poppet cartridges can be used in four (4) way hydraulic directional control valves. This type of valve can be used to control the motion of hydraulic cylinders. The four way directional control valve operates a hydraulic cylinder to extend or retract by opening and closing a combination of poppet cartridge assemblies. Multiple poppet cartridge assemblies can be assembled in a manifold and individually controlled to provide a variety of unique control valve functions.

In poppet valve applications, misalignment between the individual components of the valve cartridge assembly can create problems resulting in leakage. An area where leakage occurs is where the poppet makes contact with the liner/seat. This leakage occurs due to the lack of concentric contact between the poppet and the liner/seat. Seat bypass leakage in a poppet valve results in undesired movement of the hydraulic cylinder that the valve is controlling and can cause premature erosion of the valve seat.

Another area where leakage occurs is where the poppet makes contact with the dynamic seals. Misalignment between the poppet, liner body and the cap over the length of the poppet will create uneven loading as the poppet moves against the dynamic seal. Leakage at the dynamic seal causes premature erosion of cartridge components and erratic shifting of the valve.

Misalignment in poppet valves is typically due to manufacturing tolerances built up over multiple components that are assembled to make up the poppet cartridge. Piston actuated poppet valve designs are comprised of a one piece poppet and piston configuration fitted into a liner and then assembled into a valve housing.

Because system pressure acts to push seals out of the grooves that are machined to house them, the diametrical clearances of all mating components in the assembly must be kept to a minimum in order to prevent the seals from extruding into an open area, making the seal ineffective.

It is a manufacturing challenge to achieve the tight clearances and maintain the concentricity required to achieve an effective seal (face contact between the poppet and the liner/seat) and ensure even wear on the dynamic seals. The overall length of the one-piece poppet design makes it difficult to maintain the proper geometry.

### OVERVIEW OF EXAMPLE EMBODIMENTS

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In an example embodiment, there is described herein a poppet cartridge assembly comprising a housing with a first bore and a second bore, with the first bore having a diameter less than a diameter of the second bore. The poppet cartridge assembly comprises a poppet comprising a first section and a second section, and a floating coupler coupling the first section to the second section, wherein the floating coupler comprises a female coupler on the first section configured to accept a male coupler from the second section. The first section is sized to slide through the first bore and the second section is sized to slide though the second bore.

In an example embodiment, there is described herein a four way hydraulic directional control valve comprising a tank port, a pressure port, a first cylinder port “A” and a second cylinder port “B”. A first poppet cartridge assembly is located between the tank port and the first cylinder port. A second poppet cartridge assembly is located between the pressure port and the first cylinder port. A third poppet cartridge assembly is located between the tank port and the second cylinder port. A fourth poppet cartridge assembly is located between the pressure port and the second cylinder port. At least one of a group consisting of the first poppet cartridge assembly, the second poppet cartridge assembly, the third poppet assembly and the fourth poppet cartridge assembly comprises a two piece poppet coupled by a floating coupler.

In accordance with an example embodiment, there is described herein a method comprising connecting a first section of a poppet with a second section of a poppet via a floating coupler, and inserting the first section into a first bore of a poppet cartridge assembly, the second section slideably engaging a second bore of the poppet cartridge assembly. The second section of the poppet has a larger diameter than the first section of the poppet. The second bore has a diameter larger than the first bore.

Still other objects of the present invention will become readily apparent to those skilled in this art from the following description wherein there is shown and described a preferred embodiment of this invention, simply by way of illustration of at least one of the best modes best suited to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate examples of the present invention, and together with the description serve to explain the principles of the invention.

FIG. 1 illustrates an example of a poppet cartridge with a two-piece poppet/piston design with the poppet in the closed position.

FIG. 2 illustrates an example of an exploded view of a floating coupler for the two-piece poppet/piston design.

FIG. 3 illustrates an example of a poppet seat face contact area.

FIG. 4 illustrates an example embodiment of a poppet cartridge assembly in the open position.

FIG. 5 illustrates an example of a four way hydraulic directional control valve with poppet cartridges that have a two-piece poppet/piston design with a floating coupler.

FIG. 6 illustrates an example of a method for assembling a poppet cartridge with a two-piece poppet and piston and a floating coupler.

### DESCRIPTION OF EXAMPLE EMBODIMENTS

This description provides examples not intended to limit the scope of the invention, as claimed. The figures generally indicate the features of the examples, where it is understood and appreciated that like reference numerals are used to refer to like elements.

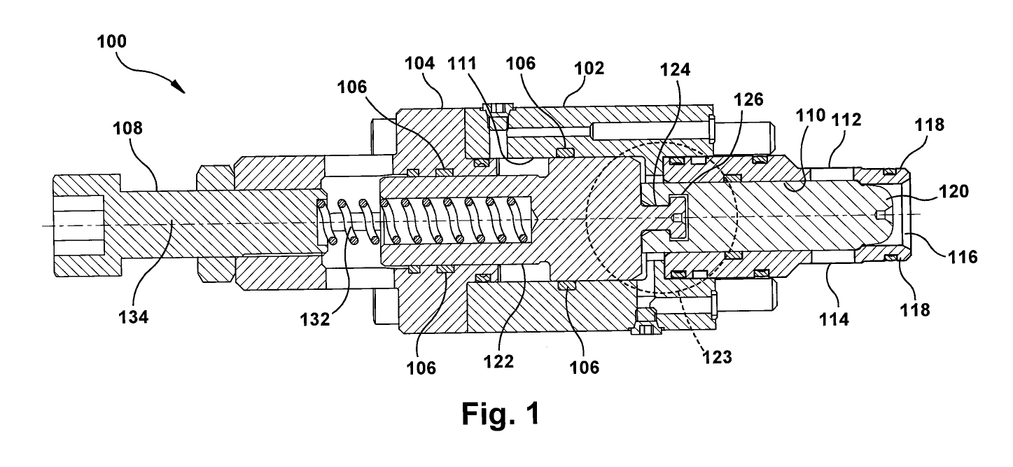

FIG. 1 illustrates an example of a poppet cartridge 100 with a two-piece poppet/piston design with the poppet in the closed position. Housing 102 and seat/liner 118 comprises a first bore 110 and a second bore 111. First bore 110 has a diameter that is less than a diameter of second bore 111. Inside housing 102 and seat/liner 118 is a poppet comprising a first section 120 and a second section 122 is coupled by a floating coupler 123. As illustrated, floating coupler 123 comprises a female coupler 126 on the first section 120 of the poppet and a male coupler 124 on the second section 122 of the poppet; however the location of the male and female couplers can be switched (e.g., first section 120 can have a female coupler and second section 122 can have the male coupler). The first section 120 of the poppet is sized to slideably engage bore 110 and the second section 122 of the poppet is sized to slideably engage bore 111. Because first bore 110 is smaller than second bore 111, second section 122 of the poppet is too large to fit into the first bore 110, limiting the motion of second section 122.

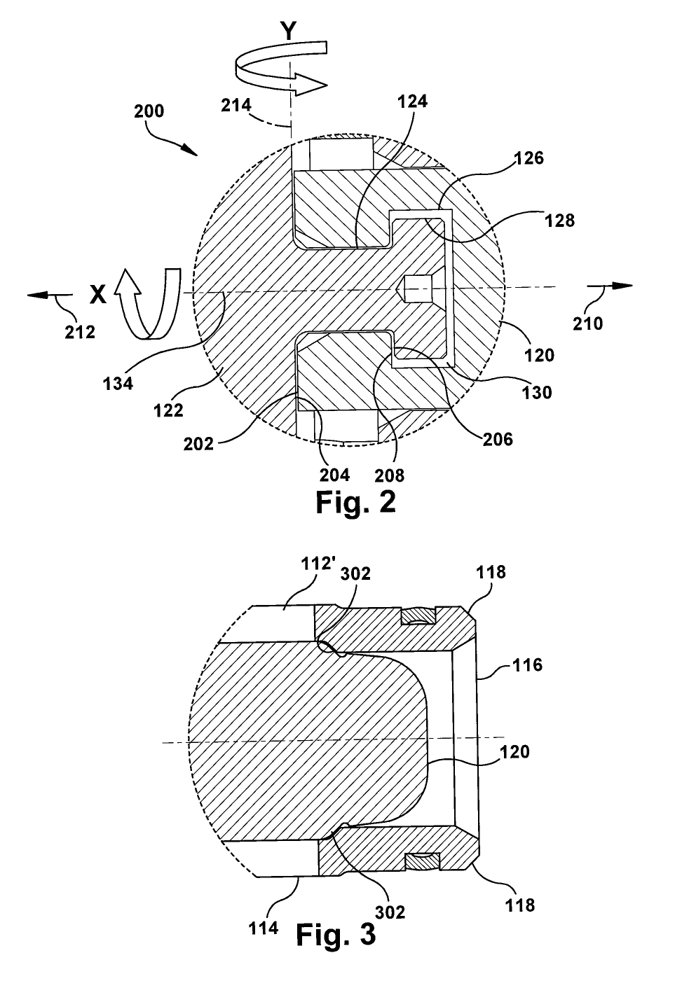

In an example embodiment described herein infra (see FIG. 2), the male coupler 124 may further comprise a second section sized to fit within a cavity of the female coupler 126. The second section of male coupler 124 is sized to engage the female coupler when the poppet is moving in one (or both) directions along a longitudinal axis. In an example embodiment, male coupler 124 is a T shaped coupler and female coupler 126 is a T shaped slot.

A cap 104 is coupled to housing 102. Cap 104 is coupled to stroke limiter 108. Cap 104 retains the poppet within housing 102. Stroke limiter 108 limits the movement of the second section 122 of the poppet along the longitudinal axis 134 of poppet cartridge 100. A stroke gap exists along axis 134 between stroke limiter 108 and the second section 122 of the poppet as provided by the cap 104, that has a viewing slot 136 and internal threads.

Dynamic seals 105 are located within seat/liner 118 and along bore 110. Dynamic seals 105 engage the first section 120 of the poppet. Because the first section 120 and second section 122 of the poppet are coupled by a floating coupler 123, this allows the first section to engage dynamic seals 105 without transmitting force on dynamic seals 105 due to misalignment of second section 122.

Dynamic seals 106 are located within cap 104 and along bore 115. Dynamic seals 106 engage the second section 122 of the poppet actuator. Because the second section 122 and first section 120 of the poppet are coupled by a floating coupler 123, this allows the second section to engage dynamic seals 106 without transmitting force on dynamic seals 106 due to misalignment of second section 120.

Dynamic seals 107 are located within housing 102 and along bore 111. Dynamic seals 107 engage the second section 122 of the poppet actuator on its large diameter. Because the second section 122 and first section 120 of the poppet are coupled by a floating coupler 123, this allows the second section to engage dynamic seals 107 without transmitting force on dynamic seals 107 due to misalignment of second section 120.

Floating coupler 123 provides axial and radial tolerance, enabling the first section 120 of the poppet to self align with bore 110 and the second section 122 of the poppet to self align with second bore 111. Floating coupler prevents the transmission of force other than linear on longitudinal axis 134 from first section 120 to second section 122 of the poppet and from second section 122 to first section 120 of the poppet.

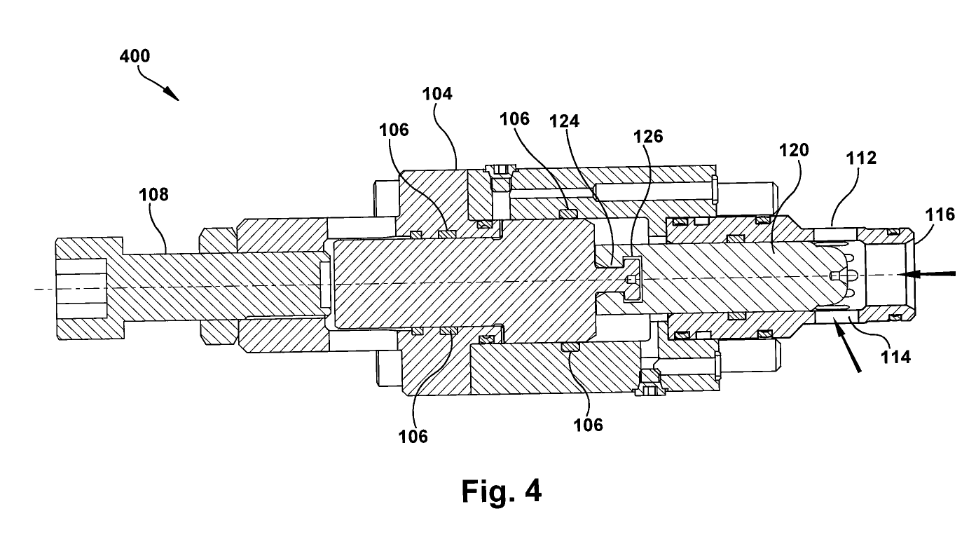

In operation, when the valve is in the closed position, the first section 120 of the poppet forms a seal with valve seat 118. This prevents fluid flow between ports 112, 114 and 116. FIG. 3 illustrates an example of the first section 120 contacting the poppet seat face contact area 302 of seat 118. To open the valve, the first section 120 and the second section 122 of the poppet are moved along longitudinal axis 134. Because of floating coupler 123 as second section 122 of the poppet slides along longitudinal axis 134 within second bore 111, any misalignment by first section 120 of the poppet within bore 110 is not transmitted to second section 122 of the poppet, to ameliorate uneven wear on seals 105, 106 and 107 and/or seat contact area 302 due to misalignment. FIG. 4 illustrates an example of the poppet cartridge in the open position 400. In FIG. 4, the first section 120 of the poppet doesn't seal against seat 118, enabling fluids to flow between ports 112, 114 and 116.

FIG. 2 illustrates an example of an exploded view of a floating coupler 200 for the two-piece poppet/piston design. Floating coupler 200 is suitable for coupler 123 (FIG. 1). In the example illustrated on FIG. 2, the floating couplers are operable to move along a longitudinal (X) axis. First section 120 comprises a female coupler 126. Female coupler 126 comprises a cavity 130. Female coupler 126 and cavity 130 are sized to receive a male coupler 124 with a second section 128 respectively.

In operation, when the poppet is moving in direction 210 along the longitudinal (X) axis 134 surface 202 of second section 122 pushes against surface 204 of first section 120. When the poppet is moving in direction 212 along the longitudinal (X) axis 134, surface 206 of second section 122 pulls against surface 208 of first section 120, causing first section 120 to move in direction 212.

An aspect of floating coupler 200 is that it can be configured to allow axial and/or radial tolerance. Moreover, with floating coupler 200, misalignment of either first section 120 or second section 122 does not transmit radial force on the valve. As illustrated in FIG. 2, female coupler 126 and/or male coupler 124 (which may also include cavity 130 and/or second section 128) can be sized to allow either first section 120, second section 122 or both to independently rotate about the longitudinal (X) axis 134. In addition, female coupler 126 and/or male coupler 124 (which may also include cavity 130 and/or second section 128) can be sized to allow either first section 120, second section 122 or both to independently occillate about a transverse (Y) axis 214. Female coupler 126 and/or male coupler 124 can be sized to allow first section 120 and/or second section 122 to rotate up to a predetermined angle (THETA “θ”) about transverse axis 214. Furthermore, male coupler 124 of second section 122 and/or female coupler 126 of first section 120 (which may also include cavity 130 and/or second section 128) can be sized to allow first section 120 and second section 122 to vary up to a predetermined angle (PHI “φ”) along longitudinal axis 134 (e.g. up to 2 degrees).

For example, referring to FIGS. 1 and 3 with continued reference to FIG. 2, if first section 120 is not aligned with poppet seat face contact area 302, floating coupler 200 enables first section 120 to center along axis 134 with poppet seat face contact area 302 without transmitting any axial or radial forces to second section 122, which alleviates second section 122 from transmitting uneven forces against seals 106 and 107. In an example embodiment, the male coupler 124 has a second section 128 that forms a T shaped coupler, and female coupler 126 comprises cavity 130 that forms a T shaped slot adapted for receiving male coupler 124 and second section 128.

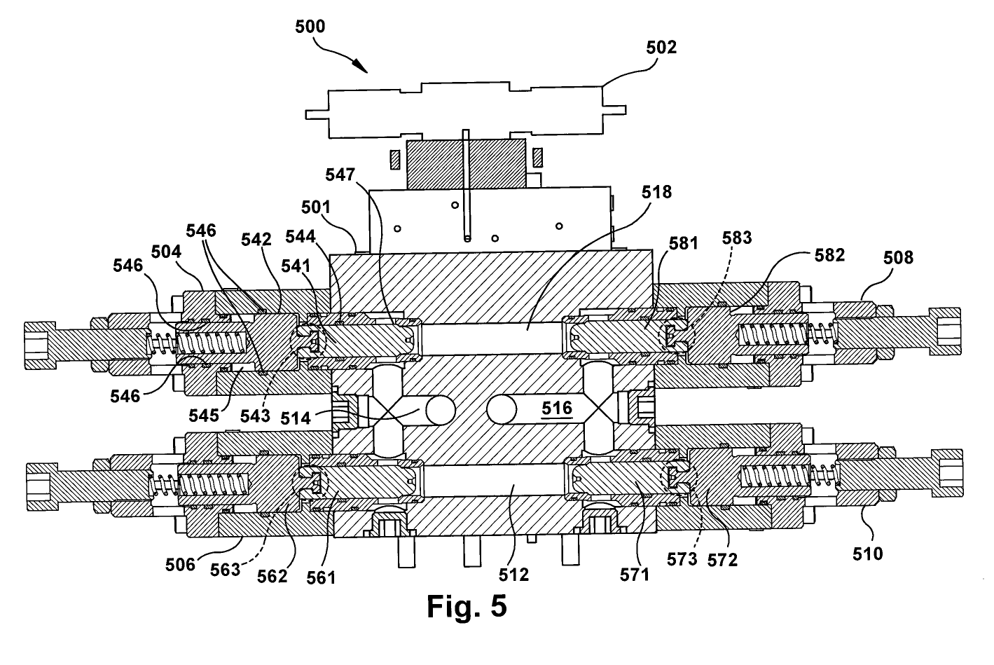

FIG. 5 illustrates an example of a four way hydraulic directional control valve 500 with poppet cartridges 504, 506, 508, 510 that have a two-piece poppet/piston design with a floating coupler. Control valve 500 also comprises a pilot valve 502.

Poppet cartridge 504 comprises a floating coupler 543 wherein section 542 has a male coupler and section 541 has a female coupler. Poppet cartridge 504 couples cylinder port 514 to tank port 518.

Poppet cartridge 506 comprises a floating coupler 563 wherein section 562 has a male coupler and section 561 has a female coupler. Poppet cartridge 506 couples cylinder port 514 to pressure port 512.

Poppet cartridge 508 comprises a floating coupler 583 wherein section 582 has a male coupler and section 581 has a female coupler. Poppet cartridge 508 couples cylinder port 516 to tank port 518.

Poppet cartridge 510 comprises a floating coupler 573 wherein section 572 has a male coupler and section 571 has a female coupler. Poppet cartridge 510 couples cylinder port 516 to pressure port 512.

Referring to poppet cartridge 504 (where poppet cartridges 506, 508, 510 are similarly configured), first section 541 slideably engages bore 544 while second section 542 slideably engages bore 545. Second section 542 engages seals 546. Floating coupler 543 provides axial and radial tolerance that enables first section 541 and second section 542 to self align within bores 544 and 545 respectively while not transmitting axial and radial forces between first section 541 and second section 542, alleviating misalignment pressure on seals 546. As illustrated bore 544 has a smaller diameter than bore 545.

As was described herein supra (see FIG. 2), floating coupler 543 can be configured to allow either first section 541 and/or second section 542 to rotate about a first axis. Optionally, the female coupler can be configured to be larger than the male coupler to enable first section 541 to vary up to a predefined angle along an axis to enable the first section to engage valve seat 547 when the valve is in a closed position.

In operation, poppet cartridge 506 is opened to provide pressure from pressure port 512 to cylinder 514, which directs energy to cylinder port 514. Poppet cartridge 504 opens to remove fluid from cylinder port 514 through tank port 518. Poppet cartridge 510 is opened to provide pressure from pressure port 512 to cylinder port 516, which directs energy to cylinder port 516. Poppet cartridge 508 opens to remove fluid from cylinder port 516 through tank port 518. With a common double acting cylinder this will allow raising/lowering or extend/retract functions.

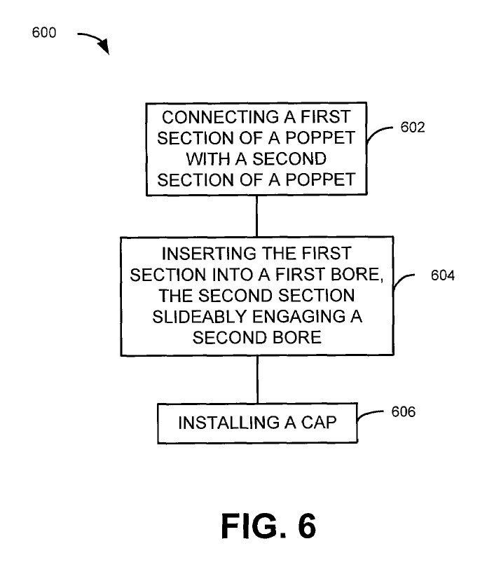

In view of the foregoing structural and functional features described above, a methodology 600 in accordance with various aspects of the present invention will be better appreciated with reference to FIG. 6. While, for purposes of simplicity of explanation, the methodology of FIG. 6 is shown and described as executing serially, it is to be understood and appreciated that the present invention is not limited by the illustrated order, as some aspects could, in accordance with the present invention, occur in different orders and/or concurrently with other aspects from that shown and described herein. Moreover, not all illustrated features may be required to implement a methodology in accordance with an aspect the present invention.

FIG. 6 illustrates an example of a method 600 for assembling a poppet cartridge with a two-piece poppet and piston and a floating coupler. At 602, a first section of a poppet is coupled to with a second section of a poppet via a floating coupler. The floating coupler may suitably comprise a male coupler and a female coupler adapted to receive the male coupler. In an example embodiment, the male coupler is T shaped and the female coupler is a T shaped slot configured to receive the T shaped male coupler. In an example embodiment, the female coupler is configured to be loose and allow the male coupler to move. This enables the first section and second section of the poppet to rotate independently about a longitudinal axis (e.g. around the X axis as illustrated in FIG. 2), occillate independently about a transverse axis (e.g. θ in FIG. 2) and move axially about a longitudinal axis (e.g. φ in FIG. 2).

At 604, the first section of the poppet is inserted into a first bore of a poppet cartridge assembly. The second section slideably engages a second bore of the poppet cartridge assembly. The second section of the poppet has a larger diameter than the first section of the poppet. This prevents the second section from sliding into the first bore and limits movement in one direction along a longitudinal axis.

At 606, a cap is installed on the poppet cartridge assembly to retain the second section of the poppet. This prevents the second section of the poppet from sliding out of the second bore. The cap (and second bore) may suitably comprise dynamic seals to prevent leakage. An aspect of the floating coupling is that misalignment of the first section of the poppet is not transmitted to the second section, which alleviates stress on dynamic seals within the second bore and/or cap.

What has been described above includes example implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims interpreted in accordance with the breadth to which they are fairly, legally and equitably entitled.

1. A poppet cartridge assembly, comprising:
a housing with a first bore and a second bore, the first bore having a diameter less than a diameter of the second bore; and
a poppet comprising a first section and a second section, and a floating coupler coupling the first section to the second section, wherein the floating coupler comprises a female coupler on the first section configured to accept a male coupler from the second section;
wherein the first section is sized to slide through the first bore and the second section is sized to slide though the second bore.

2. A poppet cartridge assembly according to claim 1, the male coupler comprises a second section, wherein the second section of the male coupler is sized to fit within a cavity of the female coupler.

3. A poppet cartridge assembly according to claim 2, wherein the second section of the male coupler is sized to engage the female coupler perpendicular to an axis of the assembly and remain engaged when the poppet is moving along a longitudinal axis in the assembly.

4. A poppet cartridge assembly according to claim 1, wherein the floating coupler is configured to allow the first section to rotate about a first axis.

5. A poppet cartridge assembly according to claim 1, wherein the female coupler is configured to be larger than the male coupler to enable the first section to vary up to a predefined angle along an axis.

6. A poppet cartridge assembly according to claim 1, wherein the female coupler is configured to be larger than the male coupler to enable the first section to vary up to a predefined angle along an axis to enable the first section to engage a valve seat when the valve is in a closed position.

7. A poppet cartridge assembly according to claim 1, wherein the male coupler is a T shaped coupler and the female coupler is a T shaped slot.

8. A poppet cartridge assembly according to claim 1, further comprising a cap mounted on the housing to retain the second section within the housing.

9. A poppet cartridge assembly, according to claim 8, wherein the cap is coupled to a stroke limiter for limiting the movement of the second section along a longitudinal axis.

10. A poppet cartridge assembly according to claim 8, further comprising a dynamic seal within the cap.

11. A poppet cartridge assembly according to claim 10, further comprising a dynamic seal mounted within the housing coupled to the second bore, the dynamic seal configured to engage the second section of the poppet.

12. A poppet cartridge assembly according to claim 11, further comprising a dynamic seal mounted within the seat/liner configured to engage on the first section of the poppet.

13. A four way hydraulic directional control valve, comprising:
a tank port;
a pressure port;
a first cylinder port;
a second cylinder port;
a first poppet cartridge assembly between the tank port and the first cylinder port;
a second poppet cartridge assembly between the pressure port and the first cylinder port;
a third poppet cartridge assembly between the tank port and the second cylinder port; and
a fourth poppet cartridge assembly between the pressure port and the second cylinder port;
wherein at least one of a group consisting of the first poppet cartridge assembly, the second poppet cartridge assembly, the third poppet assembly and the fourth poppet cartridge assembly comprises a two piece poppet coupled by a floating coupler.

14. A control valve according to claim 12, wherein the floating coupler comprises a male coupler on a first piece of the two piece poppet and a female coupler on a second piece of the two piece poppet.

15. A control valve according to claim 13, further comprising:
the male coupler having a second section, the second section having a larger diameter than the first section; and
the female coupler having a cavity sized to accept the male coupler;
wherein the second section of the male coupler is sized to remain engaged to the female coupler when the poppet is moving along a longitudinal axis.

16. A control valve according to claim 14, wherein the floating coupler is configured to allow the first section to rotate about a first axis.

17. A control valve according to claim 15, wherein the female coupler is configured to be larger than the male coupler to enable the first section to vary up to a predefined angle along an axis to enable the first section to engage a valve seat when the valve is in a closed position.

18. A method, comprising:
connecting a first section of a poppet with a second section of a poppet via a floating coupler; and
inserting the first section into a first bore of a poppet cartridge assembly, the second section slideably engaging a second bore of the poppet cartridge assembly; wherein the second section of the poppet has a larger diameter than the first section of the poppet; and
wherein the second bore has a diameter larger than the first bore.

19. A method according to claim 18, the floating coupler comprises one of a group consisting of the first section of the poppet and the second section of the poppet having a male adapter and the other of the group consisting of the first section of the poppet and the second section of the poppet having a female adapter configured to accept the male adapter.

20. A method according to claim 18, further comprising installing a cap on the poppet cartridge assembly to retain the second section of the poppet.
